(19) United States
(12) Patent Application Publication
(10) Pub. No.: US 2009/0004747 A1
(43) Pub. Date: Jan. 1, 2009

(54) FILM SENSORS FOR DETECTING FREE CHLORINE

(76) Inventors: Alan M. AGREE, Morrisville, PA (US); Scott Martell BOYETTE, New Hope, PA (US); Janine CLEMENS, Doylestown, PA (US); Prashant Vishwanath SHRIKHANDE, Eden Prairie, MN (US); Vidyasankar SUNDARESAN, Landsdale, PA (US)

Correspondence Address: General Electric Company;GE Global Patent Operation, PO Box 861, 2 Corporate Drive, Suite 648, Shelton, CT, 06484, US

(21) Appl. No.: 12/139,826

(22) Filed: Jun. 16, 2008

Related U.S. Application Data
(60) Provisional application No. 60/946,993, filed on Jun. 29, 2007.

(51) Int. Cl. G01N 31/00

(52) U.S. Cl. 436/10

(57) ABSTRACT

The present invention discloses a thin reagent containing film sensor for detecting and measuring free chlorine in water, where components of the film sensor are a polymeric substrate that contains reactive material, an organic polyhydroxy compound, a reagent that creates an associated polymeric matrix, and an indicator; and a method for making the same. The film sensor can be formed to fit a specific dimension or shape. The film sensor swells or dissolves when exposed to aqueous solutions so that said reagent is released so that it can react with free chlorine, or the film sensor swells when exposed to aqueous solutions so that the aqueous solution diffuses into the film sensor and reacts with said reagent contained within the swollen film sensor.

### CROSS REFERENCE TO RELATED APPLICATIONS

This application claims priority from U.S. Provisional Application Ser. No. 60/946,993 entitled “MODIFICATION OF FILM RESPONSE IN OPTICAL STORAGE MEDIA SUBSTRATES” filed on Jun. 29, 2007, the entirety of which is incorporated by reference herein.

### BACKGROUND OF THE INVENTION

1. Field of the Invention

The present invention relates to sensors used in optical analysis of samples, and in particular relates to film sensors for detecting and measuring free chlorine in water, and a method for making the same

2. Description of Related Art

The use of chlorine as a sanitizer or disinfectant for various water supplies and various types of equipment, like food processing equipment and medical equipment, such as a hemodialysis unit, is common. Because the amount of available chlorine in an aqueous solution relates directly to the disinfecting or sanitizing activity of the solution, a test that rapidly and accurately measures available chlorine is important.

Free available chlorine encompasses chlorine-containing compounds in aqueous solution such as hypochlorous acid, hypochlorite ion, and, in strong acid solutions, free chlorine. The use of free available chlorine as a disinfectant for water supplies and equipment is widespread because of its low cost, convenience, and effectiveness as an antiseptic agent in relatively low concentrations.

Free chlorine in water is defined as the concentration of residual chlorine in water present as one or more of dissolved gas (Cl₂), hypochlorous acid (HOCl), and hypochlorite ion (OCl⁻). The three forms of free chlorine typically exist together in equilibrium, and their relative proportions are influenced by the pH and temperature of the water. Total chlorine includes free chlorine and combined chlorine species, such as those available for disinfection (e.g., oxidants such as chloramines). Thus, one measure of a disinfection index is the total concentration of free chlorine. Another measure of a disinfection index is the total concentration of free chlorine and combined chlorine species available for disinfection.

Sensor methods and film sensors for quantification of volatile and nonvolatile compounds in fluids are known in the art. Typically, quantification of these parameters is performed using dedicated sensor systems that are specifically designed for this purpose. These sensor systems operate using a variety of principles including electrochemical, optical, acoustic, and magnetic. For example, sensor systems are used to conduct optical inspection of biological, chemical, and biochemical samples. A variety of spectroscopic sensors operating with calorimetric liquid and solid reagents have been developed. In fact, spectrophotometric indicators in analytical chemistry have become the reagents of choice in many commercially available optical sensors and probes.

Optical sensors possess a number of advantages over other sensor types, the most important being their wide range of transduction principles: optical sensors can respond to analytes for which other sensors are not available. Also, with optical sensors it is possible to perform not only “direct” analyte detection, in which the spectroscopic features of the analyte are measured, but also “indirect” analyte determination, in which a sensing reagent is employed. Upon interaction with the analyte species, such a reagent undergoes a change in its optical property, e.g. elastic or inelastic scattering, absorption, luminescence intensity, luminescence lifetime or polarization state. Significantly, this sort of indirect detection combines chemical selectivity with that offered by the spectroscopic measurement and can often overcome otherwise troublesome interference effects.

Because spectrophotometric indicators were originally developed for aqueous applications, their immobilization into a solid support is a key issue for their application in optical sensing. Polymeric materials for reagent-based optical sensors are often complex multicomponent formulations. The key formulation ingredients include a chemically sensitive reagent (indicator), a polymer matrix, auxiliary minor additives, and a common solvent or solvent mixture. In the past, it has been difficult to predict the best formulation of the sensor material to yield a certain desired functionality.

A need exists for an optical film sensor that detects free chlorine. In particular, a need exists for a cost-effective and time-saving method to create thin reagent containing film sensors that have the ability to detect and measure free chlorine.

### SUMMARY OF THE INVENTION

Disclosed are film sensors and methods for creating film sensors that detect and measure free chlorine in water. The invention is directed at creating film sensors that detect and measure free chlorine, which are made responsive by controlling film thickness and leachability of the indicator and buffer into an aqueous solution in contact with or diffused into the film sensor.

In one embodiment of the present invention, a thin reagent containing film sensor for detecting and measuring free chlorine in water is disclosed, wherein components of the film sensor are comprised of a polymeric substrate that contains reactive material, an organic polyhydroxy compound, a reagent that creates an associated polymeric matrix, and an indicator. The film sensor can be formed to fit a specific dimension or shape. The film sensor swells when exposed to aqueous solutions. If said reagent is exposed to free chlorine when the film sensor swells and the swelling allows the solution to diffuse into the film and the chlorine sensitive reagent reacts with free chlorine, then the film response will reflect the concentration of available free chlorine.

In another embodiment, a method is disclosed for creating a thin reagent containing film sensor for detecting and measuring free chlorine in water, said method comprising combining a polymeric substrate that contains reactive material, an organic polyhydroxy compound, a reagent that creates an associated polymeric matrix, and an indicator. The film sensor also has the option to be formed to fit a specific dimension or shape. The film sensor dissolves when exposed to aqueous solutions so that said reagent is exposed to free chlorine. Alternately, the film sensor swells when exposed to aqueous solutions so that the chlorine sensitive reagent diffuses out of the film, and reacts with free chlorine.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1 illustrates a response curve of a free chlorine film sensor according to one embodiment of the invention.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus. The terms “available free chlorine” and “free chlorine” are often used interchangeably in the industry, and this application anticipates their common use and uses free chlorine to refer to both free chlorine and available free chlorine.

The present application discloses and claims a thin reagent containing film sensor for detecting and measuring free chlorine in water, and a method for creating said film sensor. Sensor materials can change their optical properties in the ultraviolet (UV), visible, or near-infrared (IR) spectral range upon exposure to trace concentrations of chemical species. A film is a polymer-based composition generally including a chemically sensitive analyte-specific reagent (for example, a fluorescent or calorimetric indicator), a polymer matrix or combination of polymer matrices, and auxiliary minor additives, wherein the film is produced from a solution of the components in a common solvent or solvent mixture. The analyte-specific reagent is immobilized within the polymer matrix to form the film sensor. Examples of the auxiliary minor additives include, but are not limited to, surfactants and internal buffers. Other additives known within the art may also be included.

Polymers utilized in film sensors can be permeable to selected analytes wherein an analyte is a certain chemical species or class of chemical species which can be detected by the sensor. Analyte-specific reagents undergo changes in their optical properties (e.g., absorbance, fluorescence) as a function of analyte concentration. Desirably, an analyte-specific reagent undergoes changes in its optical property inside the film where the change in response is not affected by the presence of interfering species from any solution. Measurements of the changes or of the optical properties to determine analyte levels or concentrations are performed using optical detection systems known to those skilled in the art. For this invention, the analyte is free chlorine.

The desired response to a specific analyte is achieved by tailoring the composition of the film sensor such that the composition includes additional components in the film. For example, a desired sensor response is achieved by tailoring the oxidation potential of the immobilized analyte-specific reagent by selection of the polymer matrix components such that the polymer matrix components are additional polymers.

The polymer matrix of the film sensor is preferably permeable to selected analytes. The polymer matrix is intended to comprise a polymeric substrate that contains reactive material, an organic polyhydroxy compound, and a reagent that creates an associated polymeric matrix. The film sensor may be selectively permeable to analytes on the basis of size (i.e., molecular weight); hydrophobic/hydrophilic properties; phase (i.e., whether the analyte is a liquid, gas or solid); solubility; ion charge; the ability to inhibit diffusion of colloidal or particulate material; or the composition of the water sample besides the analyte itself, for example, the pH of the water sample during measurements.

The analyte-specific reagents are incorporated into or applied to the polymer matrix to produce the film sensor. Materials utilized as analyte-specific reagents incorporate dyes and reagents known in the art as indicators. As used herein, “analyte-specific reagents” are indicators that exhibit calorimetric, photochromic, thermochromic, fluorescent, elastic scattering, inelastic scattering, polarization, or any other optical property useful for detecting physical properties and chemical species. Analyte-specific reagents include, but are not limited to, organic and inorganic dyes and pigments, nanocrystals, nanoparticles, quantum dots, organic fluorophores, inorganic fluorophores and similar materials. In one embodiment of the present invention, the indicator is syringaldazine.

In the present invention, a thin reagent containing film sensor for detecting and measuring free chlorine in water is disclosed, wherein components of the film sensor are comprised of a polymeric substrate that contains reactive material, an organic polyhydroxy compound, a reagent that creates an associated polymeric matrix, and an indicator. The film sensor can be formed to fit a specific dimension or shape. The film sensor swells when exposed to aqueous solutions so that said adsorbed or attached reagent can then be exposed to free chlorine when a solution containing free chlorine diffuses into the film and reacts with the chlorine-specific reagent. In one embodiment, the film sensor has a thickness of less than about 20 microns. In another embodiment, the film sensor has a thickness of less than about 5 microns. The film sensor may detect free chlorine at levels of from about 0.1 ppm to about 2.0 ppm.

In another embodiment of the present invention, a method is disclosed for creating a thin reagent containing film sensor for detecting and measuring free chlorine in water, said method comprising adding a polymeric substrate that contains reactive material, an organic polyhydroxy compound, a reagent that creates an associated polymeric matrix, and an indicator. The film sensor can be formed to fit a specific dimension or shape. The film sensor swells or dissolves when exposed to aqueous solutions which releases the reagent in order that it can react with free chlorine. Alternately, the film sensor swells when exposed to aqueous solutions to allow the aqueous solution to diffuse into the film sensor and react with said reagent contained within the swollen film sensor.

An alternate embodiment provides for a film sensor where the components of the film sensor act to form hydrogen-bonded bridges between components, and produce films with the desired viscosity and consistency to form a specific dimension or shape. In another embodiment, the film sensor emits an indicator that reacts, complexes, or interacts with the free chlorine to be measured. The film sensor incorporate reagents that change their optical properties in response to a reaction or association with free chlorine, where the reaction or association-induced change can be detected by visible absorption, transmission, or emission.

Another embodiment of the invention provides a reagent emitting film sensor where the components of the film sensor act to buffer the wetted or swelled film sensor near a desirable pH, and use a reagent that creates an associated polymeric matrix, a organic polyhydroxy compound, and a polymeric substrate that contains a reactive material in prescribed ratios to form a carrier matrix. The carrier matrix of the wetted or dissolved films is buffered near a desirable pH so that chemical reactions are optimized. In one embodiment, the film sensors buffer the carrier matrix to produce a solution pH of from about 6 to about 7.

It is understood that polymeric substrates that contain reactive material used to produce the film sensor may affect the detection properties such as selectivity, sensitivity, and limit of detection. Thus, suitable materials for the film sensor are selected from polymeric substrates capable of providing the desired response time, a desired permeability, desired solubility, degree of transparency and hardness, and other characteristics relevant to the material of interest.

Suitable polymeric substrates include conducting polymers such as poly(anilines), poly(thiophenes), poly(pyrroles), poly(acetylenes), etc.; main-chain carbon polymers such as poly(dienes), poly(alkenes), poly(acrylics), poly(methacrylics), poly(vinyl ethers), poly(vinyl thioethers), poly(vinyl alcohols), poly(vinyl ketones), poly(vinyl halides), poly(vinyl nitriles), poly(vinyl esters), poly(styrenes), poly(arylenes), etc.; main-chain acyclic heteroatom polymers such as poly(oxides), poly(carbonates), poly(esters), poly(anhydrides), poly(urethanes), poly(sulfonates), poly(siloxanes), poly(sulfides), poly(thioesters), poly(sulfones), poly(sulfonamides), poly(amides), poly(ureas), poly(phosphazenes), poly(silanes), poly(silazanes), etc.; and, main-chain heterocyclic polymers such as poly(benzoxazoles), poly(oxadiazoles), poly(benzothiazinophenothiazines), poly(benzothiazoles), poly(pyrazinoquinoxalines), poly(pyromellitimides), poly(quinoxalines), poly(benzimidazoles), poly(oxindoles), poly(oxoisoindolines), poly(dioxoisoindolines), poly(triazines), poly(pyridazines), poly(piperazines), poly(pyridines), poly(piperidines), poly(triazoles), poly(pyrazoles), poly(pyrrolidines), poly(carboranes), poly(oxabicyclononanes), poly(dibenzofurans), poly(phthalides), poly(acetals), poly(anhydrides), carbohydrates, etc, and combinations thereof. The polymeric substrates can be homopolymers, copolymers of monomeric constituents of the above-mentioned polymers or resins, or polymer blends of the foregoing resins produced using methods known to those skilled in the art.

Thermoplastic polymers may be used as the polymeric substrates including, for example, resins such as poly(2-hydroxyethyl methacrylate), polystyrene, poly(α-methylstyrene), polyindene, poly(4-methyl-1-pentene), polyvinylpyridine, polyvinylformal, polyvinylacetal, polyvinylbutyral, polyvinyl acetate, polyvinyl alcohol, polyvinyl chloride, polyvinylidene chloride, polyvinyl methyl ether, polyvinyl ethyl ether, polyvinyl benzyl ether, polyvinyl methyl ketone, poly(N-vinylcarbazole), poly(N-vinylpyrrolidone), polymethyl acrylate, polyethyl acrylate, polyacrylic acid, polyacrylonitrile, polymethyl methacrylate, polyethyl methacrylate, polybutyl methacrylate, polybenzyl methacrylate, polycyclohexyl methacrylate, polymethacrylic acid, polyamide methacrylate, polymethacrylonitrile, polyacetaldehyde, polychloral, polyethylene oxide, polypropylene oxide, polyethylene terephthalate, polybutylene terephthalate, polycarbonates of bisphenols and carbonic acids, poly(diethylene glycol/bis-allylcarbonates), 6-nylon, 6,6-nylon, 12-nylon, 6,12-nylon, polyethyl asparatate, polyethyl glutamate, polylysine, polyproline, poly(γ-benzyl-L-glutamate), methyl cellulose, hydroxypropyl cellulose, acetyl cellulose, cellulose triacetate, cellulose tributylate, polyurethane resins and the like, organopolysiloxanes such as poly(phenylmethylsilane), organopolygermanium compounds, and copolymers or co-polycondensates of monomeric constituents in the above-mentioned polymers or resins. In addition, blends of the foregoing polymers may be utilized.

Other types of polymers which may be used as polymeric substrates in accordance with the present disclosure are hydrogels. As defined herein, a hydrogel is a three dimensional network of hydrophilic polymers which have been tied together to form water-swellable but water insoluble structures. The term hydrogel is to be applied to hydrophilic polymers in a dry state (xerogel) as well as in a wet state as described in U.S. Pat. No. 5,744,794.

A number of different methods may be used to tie these hydrogels together. First, tying of hydrogels via radiation or free radical cross-linking of hydrophilic polymers may be utilized, examples being poly(hydroxyethylmethacrylates), poly(acrylic acids), poly(methacrylic acids), poly(glyceryl methacrylate), poly(vinyl alcohols), poly(ethylene oxides), poly(acrylamides), poly(N-acrylamides), poly(N,N-dimethylaminopropyl-N′-acrylamide), poly(ethylene imines), sodium/potassium poly(acrylates), polysaccharides, e.g. xanthates, alginates, guar gum, agarose etc., poly(vinyl pyrrolidone), cellulose based derivatives, copolymers of monomeric constituents of the above, and combinations thereof. Second, tying via chemical cross-linking of hydrophilic polymers and monomers with appropriate polyfunctional monomers may be utilized, examples including poly(hydroxyethylmethacrylate) cross-linked with suitable agents such as N,N′-methylenebisacrylamide, polyethylene glycol diacrylate, triethylene glycol diacrylate, tetraethylene glycol dimethacrylate, tripropylene glycol diacrylate, pentaerythritol tetraacrylate, di-trimethylolpropane tetraacrylate, dipentaerythritol pentaacrylate, trimethylolpropane triacrylate, pentaerythritol triacrylate, propoxylated glyceryl triacrylate, ethoxylated pentaerythritol tetraacrylate, ethoxylated trimethylolpropane triacrylate, hexanediol diacrylate, hexanediol dimethacrylate and other di- and tri-acrylates and methacrylates; the copolymerisation of hydroxyethylmethacrylate monomer with dimethacrylate ester crosslinking agents; poly(ethylene oxide) based polyurethanes prepared through the reaction of hydroxyl-terminated poly(ethylene glycols) with polyisocyanates or by the reaction with diisocyanates in the presence of polyfunctional monomers such as triols; and cellulose derivates cross-linked with dialdehydes, diepoxides and polybasic acids; and combinations thereof. Third, tying via incorporation of hydrophilic monomers and polymers into block and graft copolymers, examples being block and graft copolymers of poly(ethylene oxide) with suitable polymers such as poly(ethyleneglycol) (PEG), acrylic acid (AA), poly(vinyl pyrrolidone), poly(vinyl acetate), poly(vinyl alcohol), N,N-dimethylaminoethyl methacrylate, poly(acrylamide-co-methyl methacrylate), poly(N-isopropylacrylamide), poly(hydroxypropyl methacrylate-co-N,N-dimethylaminoethyl methacrylate); poly(vinyl pyrrolidone)-co-polystyrene copolymers; poly(vinyl pyrrolidone)-co-vinyl alcohol copolymers; polyurethanes; polyurethaneureas; polyurethaneureas based on poly(ethylene oxide); polyurethaneureas and poly(acrylonitrile)-co-poly(acrylic acid) copolymers; a variety of derivatives of poly(acrylonitriles), poly(vinyl alcohols) and poly(acrylic acids); and combinations thereof. Molecular complex formation may also occur between hydrophilic polymers and other polymers, examples being poly(ethylene oxides) hydrogel complexes with poly(acrylic acids) and poly(methacrylic acids), and combinations thereof. Last, tying via entanglement cross-linking of high molecular weight hydrophilic polymers, examples being hydrogels based on high molecular weight poly(ethylene oxides) admixed with polyfunctional acrylic or vinyl monomers.

As noted above, copolymers or co-polycondensates of monomeric constituents of the above-mentioned polymers, and blends of the foregoing polymers, may also be utilized. Examples of applications of these materials are in Michie, et al., “Distributed pH and water detection using fiber-optic sensors and hydrogels,” J. Lightwave Technol. 1995, 13, 1415-1420; Bownass, et al., “Serially multiplexed point sensor for the detection of high humidity in passive optical networks,” Opt. Lett. 1997, 22, 346-348; and U.S. Pat. No. 5,744,794.

As set forth above, the hydrogel making up the polymer matrix is dissolved in a suitable solvent including, but not limited to di(ethylene glycol) methyl ether and ethylene glycol phenyl ether, 1-methoxy-2-propanol, ethanol, acetone, chloroform, toluene, xylene, benzene, isopropyl alcohol, 2-ethoxyethanol, 2-butoxyethanol, methylene chloride, tetrahydrofuran, ethylene glycol diacetate, and perfluoro(2-butyl tetrahydrofuran). Generally, the concentration of the solvent in the solution containing the resin is at least about 70 weight percent or greater, with one embodiment of from about 75 weight percent to about 90 weight percent and an alternate embodiment at about 80 weight percent. One preferred polymeric substrate that will be used for exemplary purposes below is poly(2-hydroxyethylmethacrylate) (pHEMA) dissolved in a solvent including of 1-methoxy-2-propanol (PM) and diethylene glycol methyl ether (DM).

Another embodiment provides for a film composition where the hydrogel or sol gel has readily available hydroxyl groups that can hydrogen bond or interact with smaller hydroxyl containing organic polyhydroxy compounds, while competing to react with plasticizer or crosslinking reagent, and the results in a mixture viscosity that has the desired fluidic or shear-induced fluidic properties to be cast or molded into the desired delivery shape. In one embodiment, the polymeric substrate is pHEMA, the organic polyhydroxy compound is glycerin, and the reagent that creates an associated polymeric matrix is boric acid. In another embodiment, the indicator is syringaldazine.

The film sensor has a viscosity that has desired fluidic or shear induced fluidic properties to be case or molded into a specific dimension or shape. In one embodiment, the film has a viscosity from about 100 cps to about 5,000 cps.

One embodiment provides a film sensor that that contains a polymeric substrate with molecular weight from about 100 to about 10,000,000. In an alternate embodiment, the polymeric substrate has a molecular weight from about 1,000 to about 500,000. Also provided for herein is a film sensor that contains organic polyhydroxy compound in an amount of from about 3% to about 20% by weight of the film sensor and the reagent that creates an associated polymeric matrix is present in an amount of from about 3% to about 20% by weight of the film sensor, resulting in a viscosity of from about 100 cps to about 5,000 cps. Additionally, the indicator is present in an amount of from about 0.5% to about 2% by weight of the film sensor.

It should be understood that various changes and modifications to the present embodiments as described herein will be apparent to those skilled in the art. Such changes and modifications can be made without departing from the spirit and scope of the present invention and without diminishing its attendant advantages. It is therefore intended that such changes and modifications be covered by the appended claims.

The invention is illustrated in the following non-limiting examples, which are provided for the purpose of representation, and are not to be construed as limiting the scope of the invention. All parts and percentages in the examples are by weight unless indicated otherwise.

### EXAMPLE 1

A 2.5 to 3.5 micron film was created. PHEMA at a Wt. % of 11.5%, Boric acid at a Wt. % from 4.5 to 7.0%, glycerin at a Wt. % from 5.0 to 9.5%, and Syringaldazine at a Wt. % of 1.3% were mixed in Diethylene glycol methyl ether and 1-Methoxy-2 propanol solvent (65/35) system. The film created demonstrated free chlorine detection from 0.1 ppm to 2.0 ppm in synthetic cooling water. The feasibility of screen printing the reported compositions was demonstrated as well as calibration curves for free chlorine.

### EXAMPLE 2

Free chlorine ink was prepared by the required materials using the following two step order of addition:

### Formulation #1

| | weight % |
|---|---|
| pHEMA stock solution | |
| 1) Poly-2-hydroxymethyl methacrylate (pHEMA) | 23.10 |
| 2) Diethylene glycol methyl ether (DM) | 49.90 |
| 3) 1-Methoxy-2-propanol (PM) | 26.90 |
| Composition | |
| 1) pHEMA stock solution (see above) | 48.74 |
| 2) Glycerin | 0.94 |
| 3) Boric acid (anhydrous) | 0.58 |
| 4) Diethylene glycol methyl ether | 31.81 |
| 5) 1-Methoxy-2-propanol | 17.13 |
| 6) Syringaldazine | 0.15 |

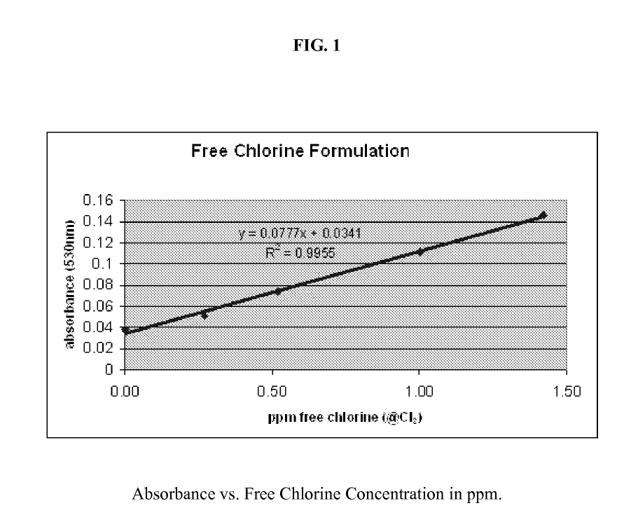

The resulting ink was screen printed onto 3.5″×5 polycarbonate plates. The solvent was evaporated leaving a thin dry square film sensors. A fluidic sampler was placed on the plate and ˜3.0 ml of water was added by means of a syringe to the sampler plate. The subsequent color change of the film sensor was measured on a commercial 96 well plate reader. Absorbance was measured via spot cluster mean at 530 nm. Table 1 shows the data from this embodiment and FIG. 1 shows the resulting graph of absorbance vs. free chlorine concentration in ppm.

TABLE 1
Absorbance vs. Available Free Chlorine

| AVC | ABS (530 nm) |
|---|---|
| 0.00 | 0.038 |
| 0.27 | 0.051 |
| 0.52 | 0.074 |
| 1.00 | 0.111 |
| 1.42 | 0.146 |

AVC=Available Free Chlorine measured by DPD method 1) Standard Methods, AWWA, 20^{th} Ed., 4500-Cl G. DPD Colorimetric Method

While the present invention has been described with references to preferred embodiments, various changes or substitutions may be made to these embodiments by those ordinarily skilled in the art pertinent to the present invention with out departing from the technical scope of the present invention. Therefore, the technical scope of the present invention encompasses not only those embodiments described above, but also all that fall within the scope of the appended claims.

What is claimed is:

1. A thin reagent containing film sensor for detecting and measuring free chlorine in water, components of said film sensor comprising:
a. a polymeric substrate that contains reactive material;
b. an organic polyhydroxy compound;
c. a reagent that creates an associated polymeric matrix; and
d. an indicator.

2. The film sensor of claim 1 wherein said film sensor can be formed to fit a specific dimension or shape.

3. The film sensor of claim 1 wherein said film sensor swells or dissolves when exposed to aqueous solutions releasing said reagent in order that it can react with free chlorine.

4. The film sensor of claim 1 wherein said film sensor swells when exposed to aqueous solutions in order that said aqueous solution diffuses into said film sensor and reacts with said reagent.

5. The film sensor of claim 1 wherein said components of said film sensor form hydrogen bonded bridges and produce films with a desired viscosity and consistency to form a specific dimension or shape.

6. The film sensor of claim 1 wherein said film sensor emits an indicator that reacts, complexes, or interacts with the free chlorine to be measured.

7. The film sensor of claim 1 wherein said film sensor incorporates reagents that change their optical properties in response to a reaction or association with free chlorine.

8. The film sensor of claim 7 wherein said reaction or association with free chlorine is detected by visible absorption, transmission, or emission.

9. The film sensor of claim 1 wherein said polymeric substrate that contains reactive material has readily available hydroxyl groups that form hydrogen bonds or interact with smaller hydroxyl containing organic polyhydroxy compounds and react with a plasticizer or crosslinking reagent.

10. The film sensor of claim 1 wherein said polymeric substrate that contains reactive material is selected from the group consisting of poly(anilines), poly(thiophenes), poly(pyrroles), poly(acetylenes), poly(alkenes), poly(dienes), poly(acrylics), poly(methacrylics), poly(vinyl ethers), poly(vinyl thioethers), poly(vinyl alcohols), poly(vinyl ketones), poly(vinyl halides), poly(vinyl nitriles), poly(vinyl esters), poly(styrenes), poly(arylenes), poly(oxides), poly(carbonates), poly(esters), poly(anhydrides), poly(urethanes), poly(sulfonates), poly(siloxanes), poly(sulfides), poly(thioesters), poly(sulfones), poly(sulfonamides), poly(amides), poly(ureas), poly(phosphazenes), poly(silanes), poly(silazanes), poly(benzoxazoles), poly(oxadiazoles), poly(benzothiazinophenothiazines), poly(benzothiazoles), poly(pyrazinoquinoxalines), poly(pyromellitimides), poly(quinoxalines), poly(benzimidazoles), poly(oxindoles), poly(oxoisoindolines), poly(dioxoisoindolines), poly(triazines), poly(pyridazines), poly(piperazines), poly(pyridines), poly(piperidines), poly(triazoles), poly(pyrazoles), poly(pyrrolidines), poly(carboranes), poly(oxabicyclononanes), poly(dibenzofurans), poly(phthalides), poly(acetals), poly(anhydrides), carbohydrates, copolymers of monomeric constituents of the above, and combinations thereof.

11. The film sensor of claim 1 wherein said polymeric substrate that contains reactive material comprises a hydrogel.

12. The film sensor of claim 11 wherein said hydrogel is tied via radical cross-linking of hydrophilic polymers selected from the group consisting of poly(acrylic acids), poly(methacrylic acids), poly(hydroxyethylmethacrylates), poly(glyceryl methacrylates), poly(vinyl alcohols), poly(ethylene oxides), poly(acrylamides), poly(N-acrylamides), poly(N,N-dimethylaminopropyl-N′-acrylamides), poly(ethylene imines), sodium poly(acrylates), potassium poly(acrylates) polysaccharides, poly(vinyl pyrrolidones), cellulose derivatives, copolymers of monomeric constituents of the above, and combinations thereof.

13. The film sensor of claim 11 wherein said hydrogel is a poly(hydroxyethylmethacrylate) hydrogel tied via chemical cross-linking with an agent selected from the group consisting of N,N′-methylenebisacrylamide, polyethylene glycol diacrylate, triethylene glycol diacrylate, tetraethylene glycol dimethacrylate, tripropylene glycol diacrylate, pentaerythritol tetraacrylate, di-trimethylolpropane tetraacrylate, dipentaerythritol pentaacrylate, trimethylolpropane triacrylate, pentaerythritol triacrylate, propoxylated glyceryl triacrylate, ethoxylated pentaerythritol tetraacrylate, ethoxylated trimethylolpropane triacrylate, hexanediol diacrylate, hexanediol dimethacrylate, and combinations thereof.

14. The film sensor of claim 11 wherein said hydrogel is a cellulose derivative tied via chemical cross-linking with an agent selected from the group consisting of dialdehydes, diepoxides, polybasic acids, and combinations thereof.

15. The film sensor of claim 11 wherein said hydrogel is a graft copolymer of poly(ethylene oxide) with polymers selected from the group consisting of poly(ethyleneglycol), poly(acrylic acid), poly(vinyl pyrrolidone), poly(vinyl acetate), poly(vinyl alcohol), N,N-dimethylaminoethyl methacrylate, poly(acrylamide-co-methyl methacrylate), poly(N-isopropylacrylamide), poly(hydroxypropyl methacrylate-co-N,N-dimethylaminoethyl methacrylate), and combinations thereof.

16. The film sensor of claim 11 wherein said hydrogel is a graft copolymer selected from the group consisting of poly(vinyl pyrrolidone)-co-polystyrene copolymers, polyurethanes, polyurethaneureas in combination with poly(ethylene oxide), polyurethaneureas in combination with poly(acrylonitrile)-co-poly(acrylic acid), poly(acrylonitrile) derivatives, poly(vinyl alcohol) derivatives, poly(acrylic acid) derivatives, and combinations thereof.

17. The film sensor of claim 1 wherein said polymeric substrate that contains reactive material comprises a polymer blend.

18. The film sensor of claim 1 wherein said polymeric substrate that contains reactive material is pHEMA.

19. The film sensor of claim 1 wherein said organic polyhydroxy compound is glycerin.

20. The film of claim 1 wherein said reagent that creates an associated polymeric matrix is boric acid.

21. The film sensor of claim 1 wherein said indicator is syringaldazine.

22. The film sensor of claim 1 wherein said film sensor has a viscosity that has desired fluidic or shear-induced fluidic properties to be cast or molded into a specific dimension or shape.

23. The film sensor of claim 22 wherein said film sensor has a viscosity from about 100 cps to about 5,000 cps.

24. The film of claim 1 wherein said polymeric substrate that contains reactive material has a molecular weight from about 100 to about 10,000,000.

25. The film sensor of claim 1 wherein said polymeric substrate that contains reactive material has a molecular weight from about 1,000 to about 500,000.

26. The film sensor of claim 1 wherein said organic polyhydroxy compound is present in an amount of from about 3% to about 20% by weight of said film sensor.

27. The film sensor of claim 1 wherein said reagent that creates an associated polymeric matrix is present in an amount of from about 3% to about 20% by weight of said film sensor.

28. The film sensor of claim 1 wherein said indicator is present in an amount of from about 0.5% to about 2% by weight of said film sensor.

29. The film sensor of claim 1 wherein said organic polyhydroxy compound and said reagent that creates an associated polymeric matrix buffers said film sensor to produce a pH of from about 6 to about 7.

30. The film sensor of claim 1 wherein said film sensor has a thickness of less than about 20 microns.

31. The film sensor of claim 1 wherein said film sensor detects free chlorine at levels of from about 0.1 ppm to about 2.0 ppm.

32. A method for creating a thin reagent containing film sensor for detecting and measuring free chlorine in water, said method comprising combining:
a. a polymeric substrate that contains reactive materials;
b. an organic polyhydroxy compound;
c. a reagent that creates an associated polymeric matrix; and
d. an indicator.
